(19) United States
(12) Patent Application Publication
(10) Pub. No.: US 2012/0329385 A1
(43) Pub. Date: Dec. 27, 2012

(54) WIRELESS COMMUNICATION METHOD

(75) Inventor: Wen-Shuo Chang, Hsinchu City (TW)

(73) Assignee: NUVOTON TECHNOLOGY CORPORATION, Hsinchu (TW)

(21) Appl. No.: 13/444,864

(22) Filed: Apr. 12, 2012

(30) Foreign Application Priority Data
Jun. 27, 2011 (TW) 100122459

(51) Int. Cl. H04B 7/24

(52) U.S. Cl. 455/39

(57) ABSTRACT

A wireless communication method is provided, and the method includes the following steps. After a first wireless communication device is powered on, an environment background signal is detected. The detected environment background signal is used to generate a random number to serve as an identity. The first wireless communication device searches for a second wireless communication device, and when the first wireless communication device has found the second wireless communication device, an identity matching procedure is executed by using the identity. After executing the identity matching procedure, wireless communication between the first and the second wireless communication devices is performed.

### CROSS-REFERENCE TO RELATED APPLICATION

This application claims the priority benefit of Taiwan application serial no. 100122459, filed on Jun. 27, 2011 The entirety of the above-mentioned patent application is hereby incorporated by reference herein and made a part of this specification.

### BACKGROUND

1. Field of the Invention

The invention relates to a communication method, and particularly, the invention relates to a wireless communication method for a wireless communication device.

2. Description of Related Art

Since a communication medium of wireless communication devices is an open space, when two wireless communication devices of the same type are within an effective range of communication, a co-channel interference problem may occur. Presently, there are several methods used to resolve the mutual interference of the wireless communication devices of the same type in the same frequency band. A first method is that a user configures the wireless communication devices to use different frequency bands. A second method is that each of the wireless communication devices has a different identity, and such identity is fixed when the wireless communication device is manufactured, so that different identities can be used to resolve the co-channel interference of the wireless communication devices of the same type. A third method is based on an identity matching procedure, in which only the wireless communication devices performed with the identity matching procedure can be connected, so as to avoid the mutual interference, and the identities used in such method are also stored in the devices as the wireless communication devices are manufactured.

However, according to the aforementioned methods, operating frequency bands are required to be configured by the user, or the identities are required to be burned into the wireless communication devices when the wireless communication devices are manufactured. As a result, it easily lacks flexibility and efficiency when it is required to adjust the wireless communication devices at both a transmitting end and a receiving end. Therefore, it is a major concern to develop a flexible and efficient wireless communication procedure while avoiding the co-channel interference.

### SUMMARY OF THE INVENTION

An embodiment of the invention provides a wireless communication method, which includes the following steps. After a first wireless communication device is powered on, an environment background signal is detected to generate a random number as a first identity. It continues to search for a second wireless communication device, and when the first wireless communication device has found the second wireless communication device, an identity matching procedure is executed by using the first identity. After the identity matching procedure is executed, wireless communication between the first and the second wireless communication devices is performed.

Another embodiment of the invention provides a wireless communication method, which includes the following steps. After a first wireless communication device is powered on, a received signal strength of a predetermined frequency band is detected to generate a random number as a first identity. It continues to search for a second wireless communication device, and when the first wireless communication device has found the second wireless communication device, an identity matching procedure is executed by using the first identity. After the identity matching procedure is executed, wireless communication between the first and the second wireless communication devices is performed.

Several embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of a wireless communication device according to an embodiment of the invention.

FIG. 2 is a flowchart illustrating a wireless communication method of using a random number to generate an identity according to an embodiment of the invention.

FIG. 3 is a flowchart illustrating another wireless communication method of using a random number to generate an identity according to an embodiment of the invention.

FIG. 4 is a flowchart illustrating another wireless communication method of using a random number to generate an identity according to an embodiment of the invention.

### DETAILED DESCRIPTION OF DISCLOSED EMBODIMENTS

In order to resolve the co-channel interference problem, in the embodiments of this invention, random numbers are used to generate different identities to implement an automatic matching procedure, and the identities are used to identify two wireless communication devices of the same type to avoid the co-channel interference. Since the identities are generated by random numbers, it is unnecessary to store the identities in the wireless communication devices in advance.

In the proposed methods for generating the random number identity, in addition to a received signal strength indicator (RSSI) being used to generate the random number identity, any other sources capable of generating the random number can also be used to generate the random number identity. For example, a first source can be a signal being read by an analog-to-digital converter (ADC), a second source can be a signal of an environmental sound or environmental background noise being read, and a third source can be a time signal of a real-time clock (RTC) being read.

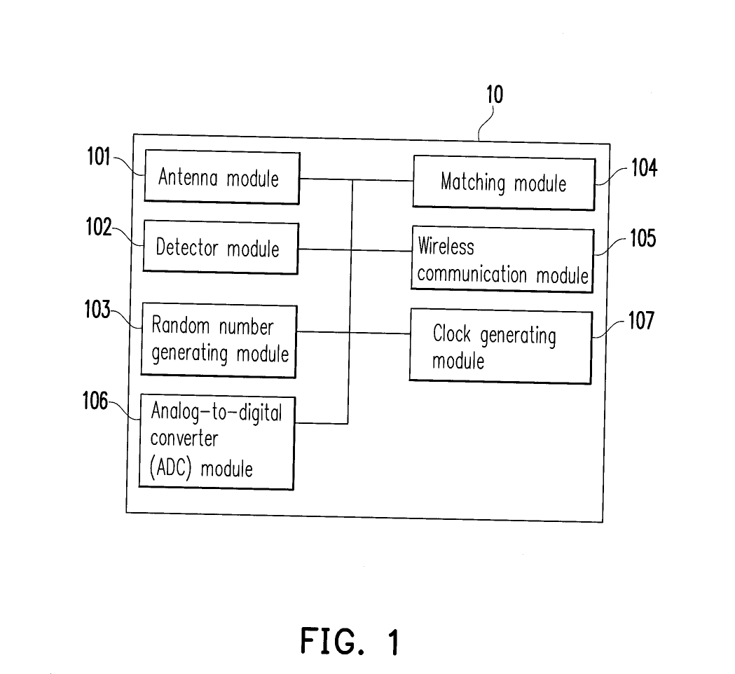

FIG. 1 is a functional block diagram of a wireless communication device 10 according to an embodiment of the invention. Referring to FIG. 1, the wireless communication device 10 includes an antenna module 101, a detector module 102, a random number generating module 103, a matching module 104, a wireless communication module 105, an ADC module 106 and a clock generating module 107.

The wireless communication device 10 further includes an input device (for example, a touch panel or a control button), an output device (for example, an audio output device or an image display device), a memory and a processor module, and so forth. Since the description of the present embodiment is to detect an environment background signal or a receive signal strength as a random number seed, and generate a random number as an identity according to the random number seed through a predetermined random number operation, and use the identity for automatic matching procedure before the wireless communication, other components of the wireless communication device 10 are not introduced in detail. The wireless communication device 10 can be any electronic device having a wireless communication function, for example, a notebook computer, a tablet computer, a mobile phone, a smart phone, a multimedia player, a television, and so forth.

Referring to FIG. 1, the antenna module 101, the detector module 102, the random number generating module 103, the matching module 104, the wireless communication module 105, the ADC module 106 and the clock generating module 107 are electrically connected to each other. Referring to FIG. 1, the antenna module 101 is configured for transmitting and receiving radio frequency (RF) signals. The detector module 102 detects RF signal in a predetermined frequency band through the antenna module 101, or directly detects (or measure) an environment background signal. The environment background signal includes environment background noise, an environment sound, humidity, temperature, brightness, a RSSI value, an RTC signal, or combinations thereof. For example, if the environment background signal is the temperature, the detector module 102 may have a temperature detecting module for detecting the temperature. The ADC module 106 converts the environment background signal detected by the detector module 102 into a digital signal, which is a background parameter index. The ADC module 106 transmits the digital signal to the random number generating module 103. Further, the ADC module 106 can also convert RF signal strength of a predetermined frequency band that is detected by the detector module 102 into an RSSI value.

The random number generating module 103 takes the digital signal of the ADC module 106 as a random number seed, and generates the random number through a random number operation. In the step of the random number operation, one of an addition operation, a subtraction operation, a multiplication operation, a division operation, an OR operation or an AND operation is performed on the random number seed to generate the random number. In other words, in the present embodiment, the random number is generated according to the random number seed through the addition operation, the subtraction operation, the multiplication operation, the division operation, the OR operation or the AND operation, or any combination of the aforementioned operations.

The RF signal strength detected in the predetermined frequency band is taken as an example to introduce a detailed technique of the random number operation. Firstly, the detector module 102 detects a random RF signal strength in the whole space through the antenna module 101. The ADC module 106 converts the RF signal strength into an RSSI value which serves as the random number seed, where the random number seed is a digital signal. The random number generating module 103 uses the random number seed to generate the random number as the identity through a predetermined random number generating operation such as the addition operation, the subtraction operation, the multiplication operation, the division operation, the OR operation or the AND operation, or any combination of the aforementioned operations.

Further, it is assumed that the detected RSSI value is an index, for example, 74, the random number generating module 103 uses the RSSI (which is 74 in the present embodiment) to obtain an A value according to a following operation: A=(((74×74)+3)÷123)−1), and the AND operation is performed according to the A value to obtain a B value: A=(B) AND (0XFFFF). Namely, the A value originally having 32 bits is performed with the AND operation to obtain the least significant bit (LSB) of 16 bits. In this way, the random number is generated to serve as the identity according to the random number seed of the RSSI value. However, the invention is not limited thereto, and the addition operation, the subtraction operation, the multiplication operation, the division operation, the OR operation or the AND operation, or any combination of the above operations can also be used to generate the random number to serve as the ID.

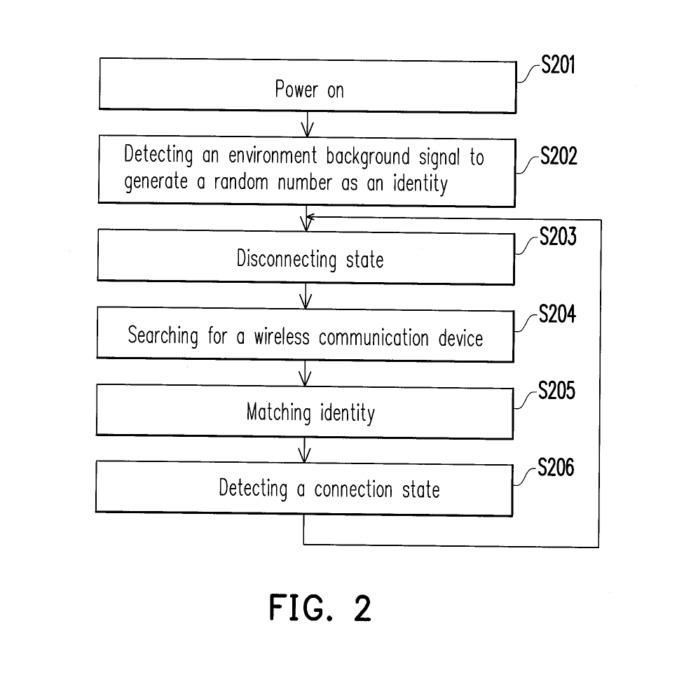

The wireless communication module 105 searches RF signals sent by the other wireless communication devices to find a wireless communication device of the same type around the wireless communication device 10, and after an identity matching procedure, wireless communication between the two wireless communication devices is performed (i.e. the two devices transmit and receive wireless packets). The matching module 104 transmits the identity generated by the random number generating module 103 to the wireless communication device to be automatically matched, or receives another identity from the other wireless communication device to complete the identity matching procedure (and an identity setting procedure therein). The clock generating module 107 is configured for generating an RTC signal, which serves as a reference signal. The random number generating module 103 can also use the currently captured RTC signal as the random number seed, so as to generate the random number as the identity. After the functions of various components of the wireless communication device 10 are introduced, detailed technical contents of a wireless communication method that uses the random number to generate the identity are described below in accordance with FIG. 2 to FIG. 4.

FIG. 2 is a flowchart illustrating a wireless communication method for using a random number to generate an identity according to an embodiment of the invention. Referring to FIG. 1 and FIG. 2, the method of FIG. 2 starts from a step S201. After the wireless communication device 10 is powered on (step S201), the detector module 102 detects an RF signal in a predetermined frequency band through the antenna module 101, or directly detects (or measure) an environment background signal, and transmits the environment background signal to the ADC module 106 and the random number generating module 103. The random number generating module 103 generates a random number as an identity according to the environment background signal (step S202). The wireless communication module 105 confirms that the wireless communication device 10 is now in a disconnected state (step S203) and is not connected to other wireless communication devices, and then the wireless communication module 105 searches for another wireless communication device (step S204). The matching module 104 matches the identities through the antenna module 101 (step S205).

The identity matching procedure performed by the matching module 104 may be illustrated in more details as follow. For example, the wireless communication module 105 may firstly transmits a radio frequency signal, which may contain an identifier of “ID01”. If there is any other wireless communication device, which has not been matched yet, in surrounding environments of the wireless communication device 10, these unmatched wireless communication devices may reply a message to the wireless communication device 10 in response to receiving the radio frequency signal which may be labelled as “ID01”. Upon receiving the replied message, the wireless communication module 105 may provide its own identifier, generated from random number generating module 103, to the wireless communication device which is to be matched, ant the wireless communication may use the received identifier for the identity matching. However, the aforementioned matching operation is merely an exemplary embodiment, and is not intended to limit implementation of the identity matching procedure of the invention. After executing the identity matching procedure, wireless communication between the first and the second wireless communication devices is performed, and a connection state therebetween is continually detected (step S206). After the step S206, it returns to execute the step S203. The proposed method illustrated in FIG. 2 can be repeatedly executed between the step S203 and the step S206 until the wireless communication device 10 is powered off.

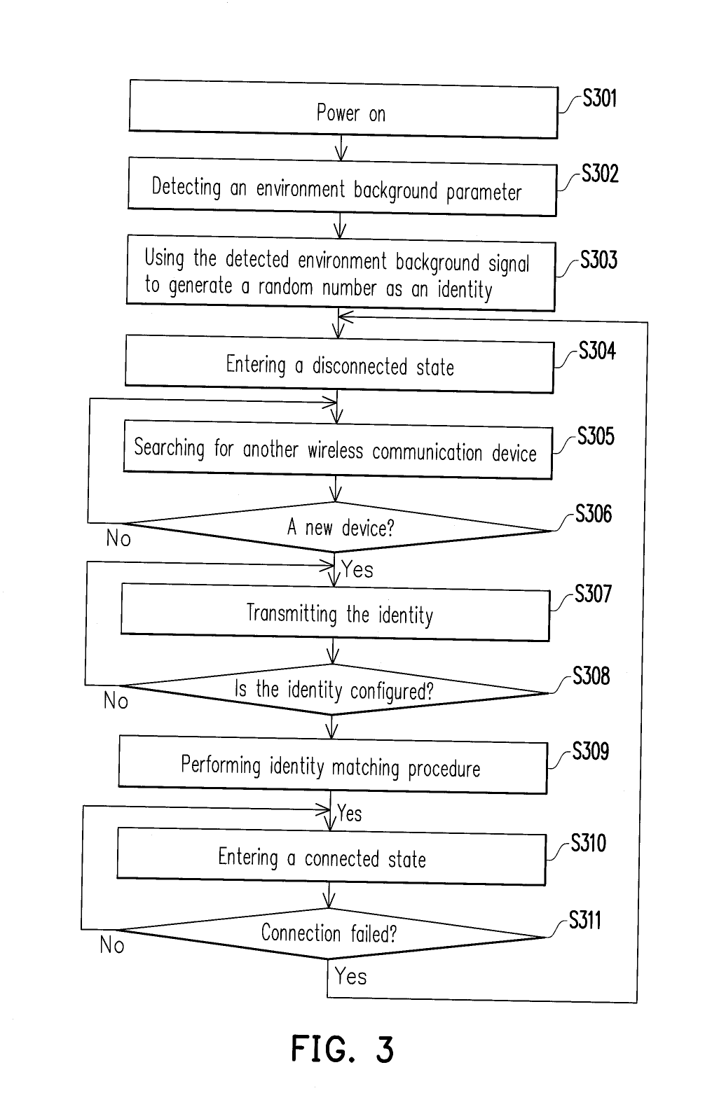

FIG. 3 is a flowchart illustrating another wireless communication method for using a random number to generate an identity according to an embodiment of the invention. Referring to FIG. 1 to FIG. 3, the flowchart of FIG. 3 further introduces the steps of FIG. 2 in detail, and the method starts from a step S301. After the wireless communication device 10 is powered on (step S301), the detector module 102 detects (or measures) an environment background signal through the antenna module 101 (step S302). The ADC module 106 converts the environment background signal into a random number seed, and transmits the random number seed to the random number generating module 103. The random number generating module 103 generates the random number, according to the random number seed, and the random number is further applied as the identity (step S303). Alternatively, in the step S303, the ADC module 106 converts the environment background signal into a background parameter index, and the random number generating module 103 takes the background parameter index as a random number seed to generate the random number through a random number operation, and detailed technical contents of the random number operation can be referred to the embodiment of FIG. 2.

The wireless communication module 105 confirms that the wireless communication device 10 is now in a disconnected state (step S304), and searches for another wireless communication devices (step S304). When the wireless communication module 105 confirms that it has found a new wireless communication device of the same type (step S306), a step S307 is executed. In the step S306, when the wireless communication module 105 does not find any new wireless communication device of the same type, it returns to execute the step S305. The matching module 104 transmits the identity to the found wireless communication device through the antenna module 101 (step S307). The matching module 104 inspects whether configuration of the identity is completed (step S308). In the step S308, when the matching module 104 confirms that the configuration of the identity is completed, the matching module 104 confirms that the identity matching procedure is completed (step S309). In the step S308, when the matching module 104 confirms that the configuration of the identity is not completed, it returns to execute the step S307.

The wireless communication module 105 communicates with the matched wireless communication device after the identity matching procedure is completed, and confirms that the wireless communication device 10 is in a connected state (step S310), and continually check the connection state (step S311). In the step S311, when the wireless communication module 105 confirms that the connection is failed, it returns to execute the step S304 and the step S305. That is, when the connection state is confirmed to be in the disconnected state, it is to search again for another wireless communication device. In the step S311, when the wireless communication module 105 confines that the connection is not failed, i.e., the device is still in the connected state, it returns to execute the step S310. The proposed method illustrated in FIG. 3 can be repeatedly executed between the step S304 and the step S311 until the wireless communication device 10 is powered off.

In the present embodiment, the step of executing the identity matching procedure may include following steps. The wireless communication device 10 (which is referred to as a first wireless communication device to facilitate the descriptions) transmits a first identity (which can be generated in the step S303) to a second wireless communication device found in the step S305. The second wireless communication device transmits a second identity (which can be generated through a step similar to the step S303) to the first wireless communication device. The first wireless communication device sets the second identity. Moreover, the second wireless communication device configures the first identity. In other words, after the first wireless communication device configures the second identity, and the second wireless communication device configures the first identity, the identity matching procedure is completed, by which the aforementioned step S308 and the step S309 are completed. Moreover, in the connected state of the step S310, a wireless communication process between the first wireless communication device and the second wireless communication device includes following situations. When the first wireless communication device transmits a first packet to the second wireless communication device, the first packet includes the second identity, and when the second wireless communication device transmits a second packet to the first wireless communication device, the second packet includes the first identity. In this way, the first wireless communication device regards a received packet to be a legitimate packet by determining that the first identity is contained in the packet, and the second wireless communication device regards a received packet to be a legitimate packet by determining that the second identity is contained in the packet, so as to avoid receiving a packet sent by a wireless communication device without performing the identity matching procedure. Moreover, in the step S311, after the wireless communication between the first and the second wireless communication device is performed, the first and the second wireless communication device still continually check the connection state therebetween.

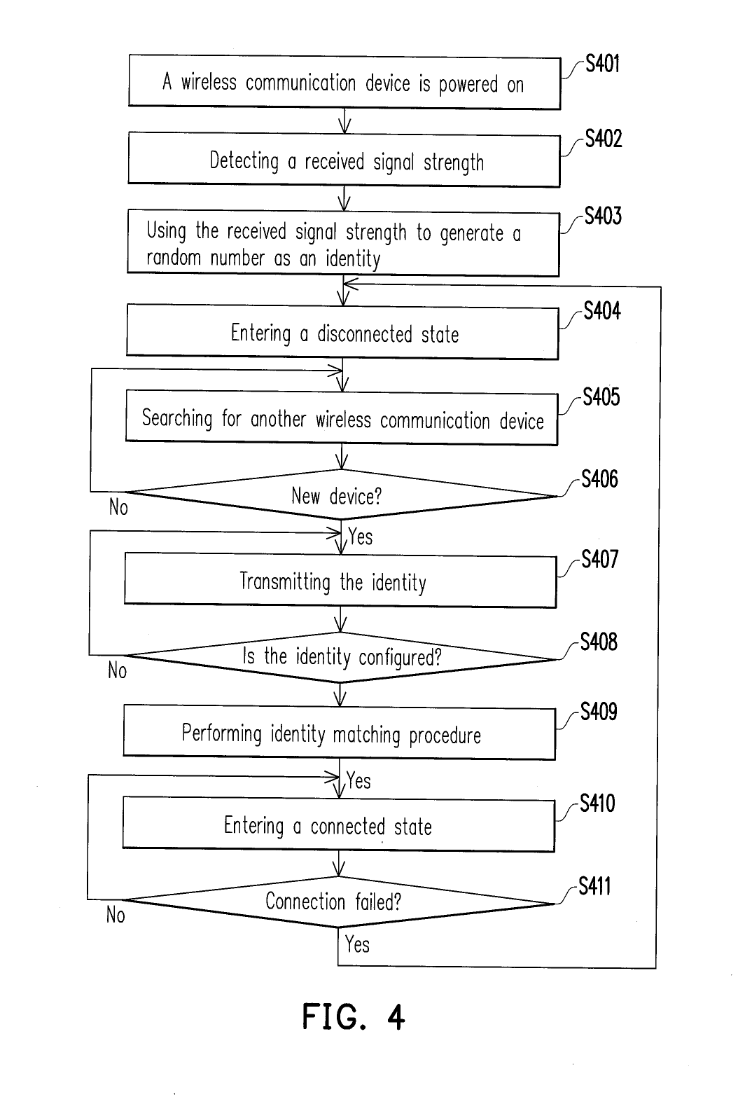

FIG. 4 is a flowchart illustrating another wireless communication method for using a random number to generate an identity according to an embodiment of the invention. Referring to FIG. 1 to FIG. 4, the method starts from a step S401. The method of FIG. 4 is similar to the method of FIG. 3, though a more detailed implementation is provided. After the wireless communication device 10 is powered on (step S401), the detector module 102 detects (or measures) an RF signal strength of a predetermined frequency band through the antenna module 101 (step S402). The ADC module 106 converts the RF signal strength into a random number seed, and transmits the random number seed to the random number generating module 103, and the random number generating module 103 generates the random number as the identity according to the random number seed (step S403). Alternatively, in the step S403, the ADC module 106 converts the RF signal strength into a received signal strength indicator, and the random number generating module 103 takes the received signal strength indicator as a random number seed to generate the random number through a random number operation. The steps S404-S411 are similar to the step S304-S311 of FIG. 3, so that the detailed descriptions thereof are not repeated herein. Moreover, the proposed method illustrated in FIG. 4 can be repeatedly executed between the step S404 and the step S411 until the wireless communication device 10 is powered off.

In the embodiments of the invention, the random number is used to generate the identity, and the identity is used for automatic matching and connection, so that it is unnecessary to burn the identity into the wireless communication device in advance during the manufacturing process, and automatic matching can be implemented without setting or intervention of users. After the matching procedure, the mutual interference of the wireless communication devices of the same type in the same space can be avoided.

Moreover, regarding the random number used in the invention, a wireless signal strength detecting function can be used to read a RSSI value in the free space to serve as a random number seed of the random number. Since the wireless signals in the free space changes frequently, the random number seed of an approximate random number can be obtained. Moreover, according to a predetermined random number generating operation, after the random number seed is configured to generate the random number to serve as the identity, the other wireless communication devices in the effective space is automatically searched for automatic matching. Once the automatic matching is successful, new identity matching is not accepted until the connection is interrupted, and interference of the products of the same type is avoided. According to the proposed method of the invention, the wireless communication devices may use the same firmware or wireless communication protocol software, and it is unnecessary to burn different product serial numbers or identities to different wireless communication devices, so that manufacturing complexity and related cost are reduced. After the wireless communication device is powered on, the other wireless communication devices suitable for matching are automatically searched without human intervention, so that matching flexibility and communication efficiency between the wireless communication devices are improved.

In summary, the invention provides a wireless communication method for using a random number to generate an identity, by which an environment background signal is detected or a signal strength is received to serve as a random number seed, and based on a predetermined random number operation, the random number is generated to serve as the identity according to the random number seed, and the identity is used for automatic matching before the wireless communication. In this way, matching of the wireless communication devices can be effectively and flexibly adjusted, and the co-channel interference problem is resolved. Moreover, manual configuration during the wireless communication process is reduced, and since the wireless communication device is unnecessary to be burned with the identity during a manufacturing process thereof, a production cost thereof is reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A wireless communication method, comprising:
detecting an environment background signal to generate a random number as a first identity after a first wireless communication device is powered on;
searching for a second wireless communication device;
executing an identity matching procedure by using the first identity when the first wireless communication device has found the second wireless communication device; and
performing a wireless communication between the first wireless communication device and the second wireless communication device after the identity matching procedure is executed.

2. The wireless communication method as claimed in claim 1, wherein the step of detecting the environment background signal to generate the random number as the first identity comprises:
converting the environment background signal into a background parameter indicator; and
using the background parameter indicator as a random number seed to generate the random number through a random number operation.

3. The wireless communication method as claimed in claim 1, wherein the step of detecting the environment background signal to generate the random number as the first identity comprises:
detecting a radio frequency signal strength of a predetermined frequency band;
converting the radio frequency signal strength into a received signal strength indicator; and
using the received signal strength indicator as a random number seed to generate the random number through a random number operation.

4. The wireless communication method as claimed in claim 1, wherein the step of executing the identity matching procedure comprises:
transmitting the first identity to the second wireless communication device by the first wireless communication device;
transmitting a second identity to the first wireless communication device by the second wireless communication device;
configuring the second identity by the first wireless communication device; and
configuring the first identity by the second wireless communication device.

5. The wireless communication method as claimed in claim 1, wherein the environment background signal is environment background noise, an environment sound, humidity, temperature, brightness, a received signal strength indicator, a real-time clock (RTC) signal, or combinations thereof.

6. The wireless communication method as claimed in claim 1, wherein after the step of performing the wireless communication between the first wireless communication device and the second wireless communication device, the method further comprises:
continually detecting a connection state between the first wireless communication device and the second wireless communication device.

7. The wireless communication method as claimed in claim 2, wherein the random number operation comprises:
performing one of an addition operation, a subtraction operation, a multiplication operation, a division operation, an OR operation or an AND operation on the random number seed to generate the random number.

8. The wireless communication method as claimed in claim 3, wherein the random number operation comprises:
performing one of an addition operation, a subtraction operation, a multiplication operation, a division operation, an OR operation and an AND operation on the random number seed to generate the random number.

9. The wireless communication method as claimed in claim 4, wherein the step of performing the wireless communication between the first wireless communication device and the second wireless communication device comprises:
when the first wireless communication device transmits a first packet to the second wireless communication device, the first packet comprises the second identity; and
when the second wireless communication device transmits a second packet to the first wireless communication device, the second packet comprises the first identity.

10. The wireless communication method as claimed in claim 6, wherein after the step of continually detecting the connection state, the method further comprises:
searching again for a wireless communication device when the connection state is confirmed to be a disconnected state.

11. A wireless communication method, comprising:
detecting a received signal strength of a predetermined frequency band to generate a random number as a first identity after a first wireless communication device is powered on;
searching for a second wireless communication device;
executing an identity matching procedure by using the first identity when the first wireless communication device has found the second wireless communication device; and
performing a wireless communication between the first wireless communication device and the second wireless communication device after the identity matching procedure is executed.

12. The wireless communication method as claimed in claim 11, wherein the step of detecting the received signal strength to generate the random number as the first identity comprises:
converting the received signal strength into a received signal strength indicator; and
using the received signal strength indicator as a random number seed to generate the random number through a random number operation.

13. The wireless communication method as claimed in claim 11, wherein the step of executing the identity matching procedure comprises:
transmitting the first identity to the second wireless communication device by the first wireless communication device;
transmitting a second identity to the first wireless communication device by the second wireless communication device;
setting the second identity by the first wireless communication device; and
setting the first identity by the second wireless communication device.

14. The wireless communication method as claimed in claim 11, wherein after the step of performing the wireless communication between the first wireless communication device and the second wireless communication device, the method further comprises:
continually detecting a connection state between the first wireless communication device and the second wireless communication device.

15. The wireless communication method as claimed in claim 12, wherein the random number operation comprises:
performing one of an addition operation, a subtraction operation, a multiplication operation, a division operation, an OR operation and an AND operation on the random number seed to produce the random number.

16. The wireless communication method as claimed in claim 13, wherein the step of performing the wireless communication between the first wireless communication device and the second wireless communication device comprises:
when the first wireless communication device transmits a first packet to the second wireless communication device, the first packet comprises the second identity; and
when the second wireless communication device transmits a second packet to the first wireless communication device, the second packet comprises the first identity.

17. The wireless communication method as claimed in claim 14, wherein after the step of continually detecting the connection state, the method further comprises:
searching again for a wireless communication device when the connection state is confirmed to be a disconnected state.
